(19) United States
(12) Patent Application Publication
(10) Pub. No.: US 2019/0373052 A1
(43) Pub. Date: Dec. 5, 2019

(54) AGGREGATION OF SCALABLE NETWORK FLOW EVENTS

(71) Applicant: Tigera, Inc., San Francisco, CA (US)

(72) Inventors: Alexander James Pollitt, San Francisco, CA (US); Amit Gupta, Fremont, CA (US)

(21) Appl. No.: 16/144,588

(22) Filed: Sep. 27, 2018

Related U.S. Application Data
(60) Provisional application No. 62/678,048, filed on May 30, 2018.

(51) Int. Cl. H04L 29/08; G06F 9/50; H04L 12/24; H04L 12/813

(52) U.S. Cl. CPC H04L 67/1008; H04L 47/20; H04L 41/069; G06F 9/5083

(57) ABSTRACT

Metadata associated with a workload is received. The workload is one of a plurality of workloads hosted on a host. A caused to generate one or more flow events associated with the workload. The one or more flow events generated by the host are processed to generate one or more corresponding scalable network flow events. A flow log comprising the one or more corresponding scalable network flow events is forwarded to a flow log receiver. The flow log receiver is configured to store the one or more corresponding scalable network flow events in a flow log store.

### CROSS REFERENCE TO OTHER APPLICATIONS

This application claims priority to U.S. Provisional Patent Application No. 62/678,048 entitled NETWORK FLOW LOGS FOR HETEROGENEOUS RESOURCES ACROSS CLOD, ON-PREM, BARE METAL, VMS, AND CONTAINERS filed May 30, 2018 which is incorporated herein by reference for all purposes.

### BACKGROUND OF THE INVENTION

Network flog logs are often used as an essential part of monitoring software applications/services for compliance, threat analytics, and operational monitoring. In a traditional on-prem environment with relatively static applications running on bare metal servers, the standard network 5-tuple (source IP address, source port, destination IP address, destination port, protocol) flow logs produced by NetFlow or IPFIX collectors have historically been sufficient to meet these needs. However, software applications/services are evolving on multiple axes: from on-prem to public cloud, from monoliths to distribute micro services, from bare metal to VMs to containers, from manually managed to automated and dynamically orchestrated.

In this evolving ecosystem, workloads and their IP addresses are more ephemeral, particularly in dynamically orchestrated container environments. As a result, traditional 5-tuple flow logs quickly lose the context of the actual workloads to which they correspond, and as a result are of limited use for compliance, threat analytics, and operational monitoring.

In addition, with the move towards micro services, scalability of traditional flow logs is becoming problematic. It is not unusual for there to be 100x more workloads in a micro services/container-based application than in an equivalent previous generation monolithic application. In addition, dynamic orchestration of containers typically means that workload IP addresses are arbitrary, so the traditional approach of aggregating 5-tuple logs based on well-known subnets housing similar workloads is no longer an option. The result can be 100x or more increase in raw flow logs, which in any scale deployment quickly becomes infeasible.

### BRIEF DESCRIPTION OF THE DRAWINGS

Various embodiments of the invention are disclosed in the following detailed description and the accompanying drawings.

FIG. 1 is a block diagram illustrating an embodiment of a system for implementing network flow logs.

FIG. 2 is a flow chart illustrating an embodiment of a process for implementing network flow logs.

FIG. 3 is a diagram illustrating workload hosts in accordance with some embodiments.

FIG. 4 is a flow chart illustrating an embodiment of a process for aggregating flow data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Network traffic analyzers are configured to collect internet protocol (IP) traffic information and to monitor network traffic. By analyzing the flow data, a picture of the network traffic flow and volume can be developed. Traditional network traffic analyzers are configured to log the standard network 5-tuple (source IP address, source port, destination IP address, destination port, protocol) flow data. Such flow data is sufficient to meet the needs of a traditional on-premises (“on-prem”) environment with relatively static applications running on bare metal servers.

However, the standard network 5-tuple flow data is not scalable for current software applications. Software applications are no longer confined to the traditional on-prem environment. Software applications have evolved from on-prem to public cloud, from monoliths to distributed micro services, from bare metal to virtual machines (VMs) to containers, from manually managed to automated to dynamically orchestrated. In this evolving ecosystem, workloads and their IP addresses are more ephemeral, particularly in dynamically orchestrated container environments. For example, an instance of a workload may be instantiated, assigned an IP address, and terminated within a short period of time. Another workload may be instantiated and assigned the same IP address as the previous workload. As workloads continue to be instantiated and torn down, the flow data associated with those workloads is aggregated in a flow log. Analyzing the flow data having the standard network 5-tuple flow data is a difficult task because using the IP address by itself is insufficient to determine which workloads sent and/or received network traffic due to the ephemeral nature of IP addresses. For example, suppose a first workload having a first IP address receives network traffic from a plurality of other entities having different IP addresses during a first time period. The first workload may be torn down and a second workload may be assigned the first IP address and receives network traffic from a plurality of other entities having different IP addresses during a second time period. Without more information beyond IP addresses, determining which workload is associated with which flow log entry is a time consuming and difficult task. A flow log entry may be associated with the first workload or the second workload, but n workloads may be assigned the first IP address during a lifetime of a workload host. The task becomes even more complex when considering the aggregated flow events associated with n workloads.

A scalable network flow event is disclosed. The scalable network flow event is configured to combine the standard network 5-tuple flow data with dynamic workload identity and/or metadata into each flow log entry in real-time as logs are being generated and recorded. For example, for a flow between two workloads with a particular orchestration system (e.g. Kubernetes), the scalable network flow event may include, for each source and destination workload one or more of the following: a cluster identity, a namespace identity, a workload identity, one or more workload labels, the standard network 5-tuple flow data, and/or network metrics associated with the flow event (e.g., number of bytes and packets). The metadata may include workload metadata and/or network policy metadata.

The scalable network flow event may be fully distributed across all hosts of a cluster to provide horizontal scalability to maintain the real-time characteristics at any scale, rather than, for example, batch processing logs centrally some time later. The cluster may be in communication with an orchestration system, a flow log receiver, and a flow log store. The orchestration system may be configured to automate deployment, scaling, and management of containerized applications within the cluster. The network flow event may include workload metadata provided by the orchestration system network plugin APIs (e.g., CNI). The orchestration system may include an API server (e.g., Kubernetes API server) that can provide additional workload metadata (e.g., names, locations, labels, annotations) of each container workload in the cluster.

In various embodiments, a cluster includes a plurality of workload hosts. A flow log agent may be deployed to each workload host of the cluster. A workload host may include a virtual machine or an on-prem-server. The workload host may be configured to run an operating system, such as Linux. The workload host may include a kernel, such as a Linux kernel. The workload host may be comprised of a plurality of workloads, such as workload containers (e.g., Docker containers). Each workload container may be a pod comprised of one or more nested containers (e.g., Kubernetes pods). In some embodiments, the workload host is comprised of a plurality of workload VMs (e.g. OpenStack VMs). In other embodiments, the workload host is comprised of a plurality of non-containerized, non-VM workloads (e.g. applications running directly on the workload host). In some embodiments, the workload hosts may be all virtual machines. In other embodiments, the workload hosts may all be on-prem servers. In other embodiments, the workload hosts may be a combination of one or more virtual machines and one or more on-prem servers.

The flow log agent may be configured to monitor the API server of the workload-orchestration system to determine the workload identity and/or metadata associated with each workload in the cluster. Such workload identity and metadata may include a cluster identity associated with a workload, a namespace identity associated with the workload, the workload identity, and/or one or more labels associated with the workload. The flow log agent may be configured to extract and correlate metadata and network policy for the one or more workloads of the workload host on which the flow log agent is deployed and the one or more workloads of the one or more other workload hosts of the cluster. For example, the flow log agent may have access to a data store that stores a data structure identifying the permissions associated with a workload. The flow log agent may use such information to determine which workloads of the cluster with which a workload is permitted to communicate and which workloads of the cluster with which the workload is not permitted to communicate.

The flow log agent may be configured to program the kernel of the workload host to which the flow log agent is deployed to generate flow events associated with each of the workloads on the workload host. The flow event may include an IP address associated with a source workload, an IP address associated with a destination workload, a source port, a destination port, a protocol, as well as the network metrics associated with the flow (e.g., number of bytes and packets). The flow log agent may be configured to combine the generated flow event with the workload identity and metadata associated with the workload and/or network policy metadata associated with the flow to generate a scalable network flow event. The scalable network flow event includes the pertinent information associated with a workload and network policy when the flow is generated. The flow log agent is configured to log the plurality of scalable network flow events into a flow log. When the flow log is reviewed at a later time, the flow log may be easily understood as to which workload communicated with which other workload in the cluster, and which network policy clauses were involved in determining whether the communication was permitted or not permitted, because each flow log entry includes the scalable network flow event.

A workload host may be comprised of a plurality of workloads. The workload host may store a flow log for the plurality of workloads. In some embodiments, the workload host is configured to store a single flow log that combines the flow events for each of the plurality of workloads. In other embodiments, the workload host is configured to store a separate flow log for each of the plurality of workloads. The amount of storage of a workload host to store the one or more flow logs is finite. However, the size of the flow log continues to expand as the plurality of workloads continue to generate flow events. Additional storage may be added or provisioned to a workload host, but the costs associated with the additional storage may be prohibitive for an entity associated with the workload host or adding storage may be unfeasible. The flow log agent may be configured to aggregate, based on the scalable network flow event, the flow events associated with each workload of the host on which the flow log agent is deployed. For example, a first workload of a workload host may communicate a plurality of times with a second workload (of the workload host or of a different workload host). Instead of storing a flow log for each of the plurality of communications, the flow log agent may combine the plurality of communications such that the single flow log indicates the number of times the first workload communicated with the second workload.

The flow log agent associated with a workload host may use the information associated with the scalable network flow event to aggregate a plurality of flow events into a single flow event. For example, the flow log agent may use the scalable network flow event to aggregate based on one or more of a hierarchy inferred from metadata associated with a workload, an entropy analysis of metadata associated with a workload, replication identity, ephemeral elements of the network 5-tuple, and/or a time interval. The aggregated flow events may include aggregated metrics across all of the flow logs that were aggregated (e.g., number of flows, sum of packets, sum of bytes, etc.).

A hierarchy may be inferred from the metadata associated with a workload. The workload may have associated metadata such as an associated cluster identity, an associated namespace identity, an associated workload identity, one or more associated workload labels, an associated region, an associated network, an associated security group, etc. A flow log agent may be configured to aggregate flow events for one or more workloads having particular metadata (and in some embodiments, not aggregate flow events for one or more workloads not having the particular metadata). For example, a flow log agent associated with a workload host may aggregate flow events for workloads having a particular cluster identity, a particular namespace identity, a particular workload identity, and/or a particular set of workload labels. A plurality of flow events having the same metadata associated with a workload may be aggregated into a single flow event. The single flow event may include an indicator that indicates the number of times that the flow occurred. For example, a workload host may include a plurality of workloads having a first workload label. Each of the workloads having the first workload label may communicate a plurality of times with a second workload. Instead of storing a flow event for each communication, the flow events for the workloads having the first workload label may be aggregated into a single flow event and the single flow event may include an indicator that indicates the number of times the workloads having the first workload label communicated with the second workload.

An entropy analysis of the metadata associated with a workload may be performed. The flow log may include a plurality of scalable network flow events associated with a workload. In some embodiments, one or more fields of the scalable network flow event may be determined to be completely random and/or not correlated with other fields or properties of a plurality of scalable network flow events. For example, a source port used by a workload for each flow event may be different. In some embodiments, the one or more fields of the scalable network flow event that are random may be discarded from the flow log. In some embodiments, the one or more fields of the scalable network flow event that are not correlated with other fields or properties of a plurality of scalable network flow events may be discarded from the flow log. This reduces the amount of storage needed to store the flow log and also enables the workload host to store more flow logs.

A replication identity associated with a workload may be determined. A workload may be associated with an instance of a micro service. There may be a plurality of micro service instances running at the same time on the same workload host, e.g., a plurality of workloads of a workload host running the same micro service. Instead of storing a flow event for each communication of micro service instances, the flow events of the micro services may be combined into a single flow log.

Elements of the standard network 5-tuple (source IP address, source port, destination IP address, destination port, protocol) may be ephemeral (e.g., lasting for a short period of time). For example, an IP address associated with a source workload of the workload host (e.g., a communication is sent from a workload of the workload host) or destination workload of the workload host (e.g., a communication is received from a workload of the workload host) may exist for a short period of time (e.g., one hour, one day, one week, etc.). A source port associated with a source workload may exist for a short period of time. A protocol associated with a communication may exist for a short period of time.

The flow events associated with the ephemeral element of the standard network 5-tuple may be aggregated. For example, the flow events associated with a duration in which a source workload has an associated IP address may be aggregated. A workload may be migrated between workload hosts and have different IP addresses on each workload host. For example, the workload may have a first IP address on a workload host and a second IP address on a different workload host. The flow events for the duration when the workload has the first IP address may be aggregated by the flow log agent associated with the workload host. The flow events for the duration when the workload has the second IP address may also be separately aggregated by the flow log agent associated with the different workload host. A flow event may include information on whether a particular flow/communication was permitted or denied. The flow event may also indicate whether the flow/communication was permitted or denied based on a network policy. The flow event may indicate the particular network policy.

The flow events associated with a duration when a workload uses a particular source port may be aggregated. For example, a workload may use a first source port for a first period of time and may use a second source port for a second period of time. The flow events for the first period of time may be aggregated by the flow log agent associated with the workload host. The flow events for the second period of time may also be separately aggregated.

The flow events associated with a duration in which a destination workload has an associated IP address may be aggregated. A workload may be migrated between workload hosts and have different IP addresses on each host. For example, the workload may have a first IP address on a first workload host and a second IP address on a second workload host. The flow events for the duration when a source workload is communicating with a destination workload having the first IP address may be aggregated. The flow events for the duration when a source workload is communicating with the destination workload having the second IP address may be separately aggregated.

The flow events associated with a duration when a workload has a particular destination port may be aggregated. For example, a workload may be a destination workload and use a first destination port for a first period of time and may use a second destination port for a second period of time. The flow events for the first period of time may be aggregated by a flow log agent. The flow events for the second period of time may also be separately aggregated.

The flow events associated with a duration in which a protocol is used may be aggregated. For example, a workload may use a first protocol during a first period of time and a second protocol during a second period of time. The flow events for the duration when the first protocol is used may be aggregated. The flow events for the duration when the second protocol is used may be separately aggregated.

The flow log agent may aggregate flow events associated with a workload for a particular time interval. For example, the flow log agent may aggregate flow events associated with a workload for the last hour, the last day, the last week, the last month, etc. Each time a particular flow event is repeated within the particular time interval, the flow log agent may aggregate the flow events instead of keeping each instance of the flow event.

The flow log agent associated with a workload host may store one or more flow logs associated with the workload host. A flow log may be comprised of one or more flow events. In some embodiments, the flow log is comprised of one or more non-aggregated flow events. In other embodiments, the flow log is comprised of one or more aggregated flow events. In other embodiments, the flow log is comprised of one or more non-aggregated flow events and one or more aggregated flow events.

The flow log agent may be configured to periodically send (e.g., every second, every hour, every day, every week, etc.) the one or more flow logs to a flow log receiver. In other embodiments, the flow log agent is configured to send the one or more flow logs to the flow log receiver in response to receiving a command. In other embodiments, the flow log agent is configured to send the flow logs to the flow log receiver after a threshold number of flow events have accumulated. After the flow log is provided to a flow log receiver, the flow log agent may delete the flow events associated with the flow log. This frees up storage for one or more subsequent flow events.

A flow log receiver is configured to receive a plurality of flow logs comprising a plurality of flow events (aggregated and/or non-aggregated) from a plurality of flow log agents, to collate the flow events, and to store the flow events in a flow log store. A cluster may be comprised of a plurality of workload hosts. The amount of storage needed to store the flow events is very large. For example, a cluster may be comprised of 1000 workload hosts. Each workload host of the cluster may generate 2000 flow events per second. Thus, the cluster as a whole may generate 2 million flow events per second. The size of a flow log store is finite. Additional storage may be added to the flow log store to store all of the generated flow events, but the costs associated with the additional storage may be prohibitive to an entity associated with the flow log store. The flow log receiver may be configured to manage the flow log store, and optimize the manner in which the flow events are stored. The scalable network flow event provides the flow log receiver with the ability to perform an additional level of aggregation on the flow events received from a plurality of flow log agents.

The flow log receiver may use the scalable network flow event to perform a second level of aggregation based on one or more of a hierarchy inferred from metadata associated with a workload, an entropy analysis of metadata associated with a workload, replication identity, ephemeral elements of the network 5-tuple, and/or a time interval. For example, the flow log receiver may determine that a plurality of workloads hosted on a plurality of workload hosts and having the same workload label are communicating with a particular workload. The flow log receiver may combine the flow events received from a plurality of workload hosts for the workloads having the same workload label into a single flow event indicating the number of times the workloads having the same workload label communicated with the particular workload.

Since the flow log receiver has a complete picture of the network flows for the cluster, the flow log receiver may combine flow events (aggregated and non-aggregated) from a plurality of workload hosts. For example, a workload may be hosted on a first workload host and have a first IP address. The workload may be migrated to a second workload host and have a second IP address. The flow events of the workload that occurred while on the first workload host and the second workload host may be aggregated because the flow log receiver has the metadata associated with the workload. The workload while hosted on the first workload host may communicate a plurality of times with a second workload. The workload while hosted on the second workload host may also communicate a plurality of times with the second workload. Each respective flow log agent may aggregate the flow events into a single flow event. The flow log receiver may receive the aggregated flow events from the flow log agent of the first workload host and the flow log agent of the second workload host. Instead of storing two separate flow events, the flow log receiver may perform a second level of aggregation and combine the flow event from the flow log agent of the first workload host with the flow event from the flow log agent of the second workload host because the flow log receiver knows that the flow events are associated with the same workload.

After the flow log receiver has stored a plurality of flow events to a flow log store, the flow log receiver may be configured to perform an additional level of aggregation on the stored flow events. The flow log receiver is configured to monitor the amount of storage used by the flow log store to store the flow events. In some embodiments, the flow log receiver performs an additional level of aggregation on the stored flow events based on one or more of a hierarchy inferred from metadata associated with a workload, an entropy analysis of metadata associated with a workload, replication identity, ephemeral elements of the network 5-tuple, and/or a time interval. For example, the flow log store may receive and store sets of flow events. A first set may be associated with a first time period and a second set may be associated with a second time period. A flow event associated with the first time period may indicate that a first workload has communicated a plurality of times with a second workload. A flow event associated with the second time period may indicate that the first workload has communicated a plurality of times with the second workload. Instead of storing two separate flow events for the two time periods, the flow log receiver may be configured to optimize the stored flow events and combine the flow events into a single flow event indicating the number of times that the first workload communicated with the second workload. This helps to reduce the amount of storage used by the flow log store to store the flow logs and allows the flow log store to store additional flow logs.

In some embodiments, the flow log receiver is configured to remove one or more stored flow events from the flow log store based on one or more retention policies. For example, a policy may indicate that flow events for workloads having a particular label are to be removed from the flow log store after a particular period of time (e.g., 1 year). In the event the flow event is a non-aggregated flow event, the flow log receiver may be configured to remove the flow event from the flow log store. In the event the flow event is an aggregated flow event and one or more flow events of the aggregated flow event occurred after the particular period of time, the flow log receiver is configured to keep the flow event, but decrease the indicator associated with the flow event by the number corresponding to the one or more events that occurred after the particular period of time. For example, suppose an aggregated flow event indicates that a particular flow occurred ten times. Three of those flow events may have occurred after the particular period of time. The flow log receiver is configured to keep the flow event, but decrease the indicator such that it indicates that the particular flow occurred seven times. In the event the flow event is an aggregated flow event and all of the flow events of the aggregated flow event occurred after the particular period of time, the flow log receiver is configured to remove the flow event form the flow log store. This also helps to reduce the amount of storage used by the flow log store to store the flow logs and allows the flow log store to store additional flow logs.

The level of aggregation performed by the flow log agent and/or the flow log receiver is dynamically automated based on an assessment of the significance of an individual flow event and a load on the overall processing and storage system. For example, if a flow is unexpected, then the full details of the flow may be recorded without any aggregation, but if a flow is business as usual, i.e., expected, and there is pressure on the storage, then the flow may be aggregated with other flows of the same type. For example, heuristics may be used to determine whether a flow is expected. Heuristics may also be used to consider the network policy associated with the workloads, dynamically learn traffic patterns for the workloads, and pattern match thresholds or other operator defined criteria. Similarly, under a distributed denial of service (DDOS) attack, the level and mix of aggregation decisions will dynamically adjust in such a way to ensure there is a mix of detailed logs for forensics and aggregated logs to determine the overall volume and shape of the attack.

Flow log aggregation may also be automatically adjusted based on incident detection machine learning pipelines. For example, if a particular flow metric is determined to be abnormal (based on machine learning of patterns across multiple metrics over time), more aggressive flow logging corresponding to the particular flow metric will be automatically enabled. The more aggressive flow logs are fed into a compromise analysis pipeline. If a compromise is confirmed, then automate corrective actions may be triggered, for example, isolating a compromised workload. This helps to ensure that the workloads and workload hosts of the cluster are working properly and are not compromised.

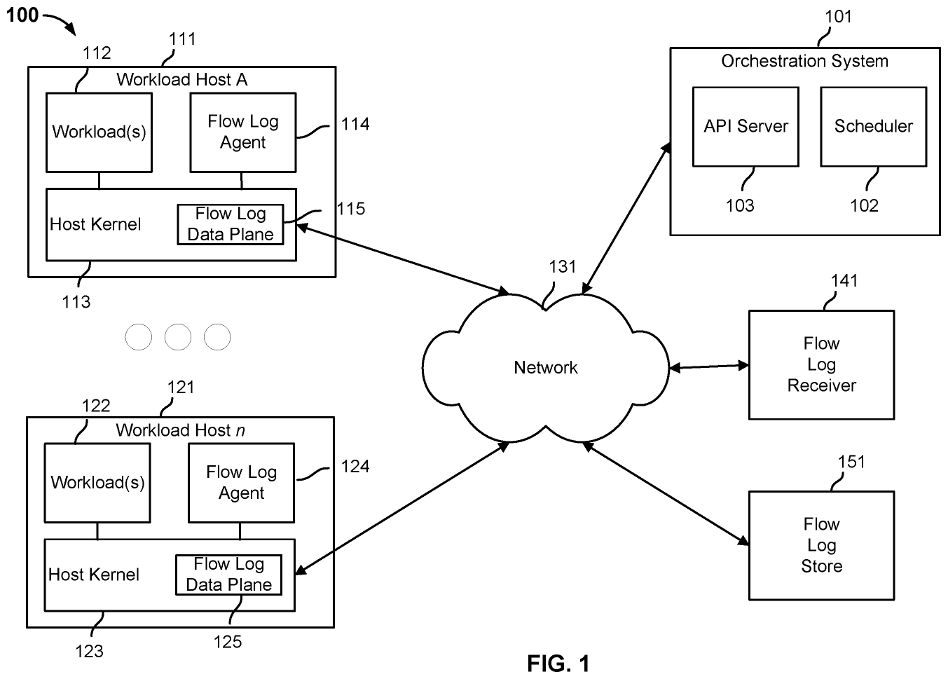

FIG. 1 is a block diagram illustrating an embodiment of a system for scalable network flow events. In the example shown, system 100 comprises Orchestration System 101, Workload Host 111, Workload Host 121, Network 131, Flow Log Receiver 141, and Flow Log Store 151.

System 100 may include one or more clusters comprising a plurality of workload hosts. A workload host may be considered to be a node of one of the one or more clusters. Although system 100 depicts two workload hosts, system 100 may include n workload hosts where n is an integer greater than one. In some embodiments, Workload Hosts 111, 121 are virtual machines running on a computing device, such as a computer, server, etc. In other embodiments, Workload Hosts 111, 121 are running on a computing device, such as on-prem servers, laptops, desktops, mobile electronic devices (e.g., smartphone, smartwatch), etc. In other embodiments, Workload Hosts 111, 121 are a combination of virtual machines running on one or more computing devices and one or more computing devices. Workload Hosts 111, 121 run an associated operating system (e.g., Windows, MacOS, Linux, etc.) and include an associated Kernel 114, 124 (e.g., Windows kernel, MacOS kernel, Linux kernel, etc.). Workload Hosts 111, 121 may have a corresponding set of one or more workloads that are pods (e.g., containers that may themselves contain nested groups of containers)112, 122.

Orchestration System 101 is a system configured to automate, deploy, scale, and manage containerized applications. Orchestration System 101 is configured to orchestrate computing, networking, and storage infrastructure on behalf of user workloads. Orchestration System 101 is configured to generate a plurality of workloads. A workload is a deployable unit of computing. A service is comprised of a plurality workloads. Orchestration System 101 may include a scheduler 102. Scheduler 102 may be configured to deploy the workloads to one or more workload hosts. In some embodiments, the workloads are deployed to the same workload host. In other embodiments, the workloads are deployed to a plurality of workload hosts. Scheduler 102 may be configured to deploy the workloads to one or more workload hosts based on one or more factors. For example, Scheduler 102 may deploy a plurality of workloads to a plurality of workload hosts to spread the workloads across the plurality of workload hosts. Scheduler 102 may avoid deploying a workload to a workload host with insufficient free resources. Scheduler 102 may co-locate a plurality of workloads on the same workload host in the event the plurality of workloads frequently communicate with each other.

Scheduler 102 may deploy a workload to a workload host based on a label attached to the workload. The label may be a key-value pair. Labels are intended to be used to specify identifying attributes of workloads that are meaningful and relevant to users, but do not directly imply semantics to the core system. Labels may be used to organize and to select subsets of workloads. Labels can be attached to a workload at creation time and subsequently added and modified at any time. A user may configure a workload host such that only workloads with a particular label may be deployed to a particular workload host.

A workload may have associated metadata. For example, a workload may be associated with a cluster identity, a namespace identity, a workload identity, and/or one or more workload labels. The cluster identity identifies a cluster to which the workload is associated. A cluster is comprised of a plurality of workload hosts. System 100 may be comprised of one or more clusters. The namespace identity identifies a namespace to which the workload is associated. System 100 may support multiple virtual clusters backed by the same physical cluster. These virtual clusters are called namespaces. Namespaces are a way to divide cluster resources between multiple users. For example, system 100 may include namespaces such as “default,” “kube-system” (a namespace for objects created by an orchestration system, such as Kubernetes), and “kube-public” (a namespace created automatically and is readable by all users). The workload identity identifies the workload. A workload is assigned a unique ID.

The metadata associated with a workload may be stored by API Server 103. API Server 103 is configured to store the names and locations of each workload in system 100. API Server 103 may be configured to communicate using JSON. API Server 103 is configured to process and validate REST requests and update state of the API objects in etcd (a distributed key value datastore), thereby allowing users to configure workloads and containers across workload hosts.

A workload may include one or more containers. A container may be configured to implement a virtual instance of a single application or micro service. The one or more containers of the workload will share the same resources and local network of the workload host on which the workload is deployed. A container of a workload may easily communicate with another container of the workload as though they were on the same machine while maintaining a degree of isolation from others.

When deployed to a workload host, a workload has an associated IP address. The associated IP address is shared by the one or more containers of a workload. The lifetime of a workload may be ephemeral in nature. As a result, the IP address assigned to the workload may be reassigned to a different workload that is deployed to the workload host. In other embodiments, a workload is migrated to a different workload host of the cluster. The workload may be assigned a different IP address on the different workload host.

Workload Host 111 is configured to receive a set of one or more workloads 112 received from Scheduler 102. Each workload of the set of one or more workloads 112 has an associated IP address. A workload of the set of one or more workloads 112 may be configured to communicate with another workload of the set of one or more workloads 112. A workload of the set of one or more workloads 112 may be configured to communicate with another workload located in the system 100, for example, one of workloads included in the set of one or more workloads 122. A workload of the set of one or more workloads 112 may be configured to communicate with an endpoint external to system 100. When a workload is terminated, the IP address assigned to the terminated workload may be reused and assigned to a different workload. A workload may be destroyed. Each time a workload is resurrected, it is assigned a new IP address. A workload may be migrated to a different workload host, for example, Workload Host 121. The migrated workload is assigned to a different IP address and the IP address assigned to the workload may be reused and assigned to a different workload. In some embodiments, a new workload is deployed to a workload host, for example, Workload Host 111 or Workload Host 121. The new workload may be prevented from communicating with other workloads until a flow log agent of the workload host on which the new workload is deployed receives metadata associated with the new workload from API Server 103. The new workload may have associated metadata that indicates one or more workloads with which the new workload is allowed to communicate. For example, a new workload may have a “red” label and a network policy associated with system 100 may indicate that workloads having a “red” label are only allowed to communicate with other workloads having a “green” label. Thus, the new workload may not be allowed to communicate with a workload having a “blue” label. A workload may be a container, a pod, a virtual machine, or a host.

Workload Host 111 includes a Host Kernel 113. Host Kernel 113 is configured to control access to the CPU associated with Workload Host 111, memory associated with Workload Host 111, input/output requests associated with Workload Host 111, and networking associated with Workload Host 111.

Flow Log Agent 114 may be configured to monitor API Server 103 to determine metadata associated with one or more workloads. In some embodiments, Flow Log Agent 114 is configured to determine the metadata associated with the set of one or more workloads 112. In other embodiments, Flow Log Agent 114 is configured to determine the metadata associated with the one or more workloads included in a cluster, for example, the metadata associated with the set of one or more workloads 112 and the set of one or more workloads 122. The metadata associated with a workload may include a cluster identity associated with a workload, a namespace identity associated with the workload, the workload identity, and/or one or more labels associated with the workload.

Flow Log Agent 114 may be configured to extract and correlate metadata and network policy for the one or more workloads of Workload Host 111 and the one or more workloads of the one or more other workload hosts of the cluster. For example, Flow Log Agent 114 may have access to a data store that stores a data structure identifying the permissions associated with a workload. Flow Log Agent 114 may use such information to determine which workloads of the cluster to which a workload is permitted to communicate and which workloads of the cluster to which the workload is not permitted to communicate.

Flow Log Agent 114 may be configured to program Kernel 113 to include Flow Log Data Plane 115. Flow Log Data Plane 115 is configured to cause Kernel 113 to generate flow events associated with each of the workloads on the host. A flow event may include an IP address associated with a source workload and a destination workload, a source port, a protocol used, as well as the network metrics associated with the flow. For example, a first workload of the set of one or more workloads 112 may communicate with another workload in the set of one or more workloads 112 or a workload included in the set of one or more workloads 122. The Flow Log Data Plane 115 may cause Host Kernel 113 to record the standard network 5-tuple as a flow event and to provide the flow event to Flow Log Agent 114. In some embodiments, the Flow Log Data Plane 115 is configured to cause Kernel 113 to include workload metadata and/or network policy metadata in the generated flow events.

In response to receiving the flow event from Host Kernel 113, Flow Log Agent 114 may be configured to process with the flow event by adding the metadata of the workload and/or network policy metadata for which the flow event is associated. For example, the Host Kernel 113 may provide a flow event that includes the source IP address, the source port, the destination IP address, the destination port, and the protocol. The flow event may also include network metrics associated with the flow, such as the number of bytes and packets. Flow Log Agent 114 is configured to determine the workload to which the flow event pertains. Flow Log Agent 114 may determine this information based on the IP address associated with a workload or based on network interface associated with a workload. Flow Log Agent 114 is configured to combine the flow event information with metadata associated with the workload, such as the cluster identity associated with the workload, a namespace identity associated with the workload, the workload identity, and/or one or more labels associated with the workload. Flow Log Agent 114 is configured to combine the flow event information with metadata associated with the network policy related to the flow event, such as the list of network policy clauses that resulted in the communication being permitted or not permitted. Flow Log Agent 114 is configured to store the combined flow event as a scalable network flow event. Each event included in the flow log includes the pertinent information associated with a workload when the flow log entry is generated. Thus, when the flow log is reviewed at a later time, the flow log may be easily understood as to which workload communicated with which other workload in the cluster, and which network policy clauses were involved in determining whether the communication was permitted or not permitted.

In some embodiments, one of the workloads included in the set of one or more workloads 112 is communicating with an unknown endpoint. In the event a workload is communicating with an unknown endpoint (i.e., metadata associated with the endpoint is unknown), Flow Log Agent 114 is configured to generate a flow event that includes the metadata associated with the workload, the standard network 5-tuple, the network metrics associated with the flow, and information associated with the IP addresses of the unknown endpoint (e.g., public/private).

In some embodiments, Flow Log Agent 114 may prevent a workload from communicating with another workload on the workload host, another workload external to the workload host but part of the system 100, or to an endpoint external to the system 100, until Flow Log Agent 114 receives from API Server 103 the metadata associated with the workload.

Flow Log Agent 114 is configured to aggregate flow events associated with the set of one or more workloads 112. Flow Log Agent 114 may store the flow events associated with the workload host in a flow log and periodically (e.g., every hour, every day, every week, etc.) send the flow log to Flow Log Receiver 141. In other embodiments, Flow Log Agent 114 is configured to send a flow log to Flow Log Receiver 141 in response to receiving a command. In other embodiments, Flow Log Agent 114 is configured to send a flow log to Flow Log Receiver 141 after a threshold number of flow event entries have accumulated in the flow log.

Instead of accumulating each flow event associated with Workload Host 111 and sending each flow event to Flow Log Receiver 141, Flow Log Agent 114 may use the information associated with the scalable network flow event to aggregate a plurality of flow events into a single flow event. For example, a first workload of the one or more workload workloads 112 may communicate a plurality of times with a second workload (of Workload Host 111 or of Workload Host 121). Instead of storing a flow log entry for each of the plurality of communications, Flow Log Agent 114 may combine the plurality of flow events such that a single flow event indicates the number of times the first workload communicated with the second workload.

Flow Log Agent 114 may use the information associated with the scalable network flow event to aggregate a plurality of flow logs associated with Workload Host 111 into a single flow event based on one or more of a hierarchy inferred from metadata associated with a workload, an entropy analysis of metadata associated with a workload, replication identity, ephemeral elements of the network 5-tuple, and/or a time interval. The aggregated flow events may include aggregated metrics across all of the flow logs that were aggregated (e.g., number of flows, sum of packets, sum of bytes, etc.).

A hierarchy may be inferred from the metadata associated with a workload. The workload may have associated metadata such as an associated cluster identity, an associated namespace identity, an associated workload identity, one or more associated workload labels, an associated region, an associated network, an associated security group, etc. An example of metadata hierarchy is OpenStack, which may have cluster, region, network, security group, and other things in the hierarchy. Flow Log Agent 114 may be configured to aggregate flow events for one or more workloads having particular metadata (and in some embodiments, not aggregate flow events for one or more workloads not having the particular metadata). For example, Flow Log Agent 114 may aggregate flow logs for workloads having a particular cluster identity, a particular namespace identity, a particular workload identity, and/or a particular workload label. A plurality of flow events having the same metadata associated with a workload may be aggregated into a single flow event. The single flow event may include an indicator that indicates the number of times that the flow occurred. For example, Workload Host 111 may include a plurality of workloads having a first workload label. Each of the workloads having the first workload label may communicate a plurality of times with a second workload. Instead of storing a flow event for each communication, the flow events for the workloads having the first workload label may be aggregated into a single flow event and the single flow event may include an indicator that indicates the number of times the workloads having the first workload label communicated with the second workload.

An entropy analysis of the metadata associated with a workload may be performed. The flow log may include a plurality of scalable network flow events associated with a workload. In some embodiments, one or more fields of the scalable network flow event may be determined to be completely random. For example, a source port used by a workload for each flow event may be different. In some embodiments, Flow Log Agent 114 may discard the one or more fields of the scalable network flow event that are random from the flow log. This reduces the amount of storage needed to store the flow log and also enables the workload host to store more flow logs.

A replication identity associated with a workload may be determined. A workload may be associated with an instance of a micro service. There may be a plurality of micro service instances running at the same time, e.g., a plurality of workloads of a workload host running the same micro service. Instead of storing a flow log for each communication of micro service instances, Flow Log Agent 114 may be configured to combine the flow logs of the micro services into a single flow log.

Elements of the standard network 5-tuple (source IP address, source port, destination IP address, destination port, protocol) may be ephemeral (e.g., lasting for a short period of time). For example, an IP address associated with a source workload of Workload Host 111 (e.g., a communication is sent from a workload of the workload host) or destination workload of Workload Host 111 (e.g., a communication is received from a workload of the workload host) may exist for a short period of time (e.g., one hour, one day, one week, etc.). A source port associated with a source workload may exist for a short period of time. A protocol associated with a communication may exist for a short period of time.

The flow events associated with the ephemeral element of the standard network 5-tuple may be aggregated. For example, the flow events associated with a duration in which a source workload has an associated IP address may be aggregated. A workload may be migrated between Workload Host 111 and Workload Host 121 and have different IP addresses on each workload host. For example, the workload may have a first IP address on Workload Host 111 and a second IP address on Workload Host 121. The flow events for the duration when the workload has the first IP address may be aggregated by Flow Log Agent 114. The flow events for the duration when the workload has the second IP address may also be separately aggregated by Flow Log Agent 124.

The flow events associated with a duration when a workload uses a particular source port may be aggregated. For example, one of the workloads 112 may use a first source port for a first period of time and may use a second source port for a second period of time. The flow events for the first period of time may be aggregated by Flow Log Agent 114. The flow events for the second period of time may also be separately aggregated.

The flow events associated with a duration in which a destination workload has an associated IP address may be aggregated. A workload may be migrated between workload hosts and have different IP addresses on each host. For example, one of the workloads 112 may have a first IP address on Workload Host 111 and a second IP address on Workload Host 121. The flow events for the duration when a source workload is communicating with one of the workloads 112 having the first IP address may be aggregated. The flow events for the duration when a source workload is communicating with one of the workloads 112 having the second IP address may be separately aggregated.

The flow events associated with a duration when a workload has a particular destination port may be aggregated. For example, one of the workloads 112 may be a destination workload and use a first destination port for a first period of time and may use a second destination port for a second period of time. The flow events for the first period of time may be aggregated by Flow Log Agent 114. The flow events for the second period of time may also be separately aggregated.

The flow events associated with a duration in which a protocol is used may be aggregated. For example, one of the workloads 112 may use a first protocol during a first period of time and a second protocol during a second period of time. The flow events for the duration when the first protocol is used may be aggregated by Flow Log Agent 114. The flow events for the duration when the second protocol is used may be separately aggregated by Flow Log Agent 114.

Flow Log Agent 114 may aggregate flow events associated with a workload for a particular time interval. For example, Flow Log Agent 114 may aggregate flow events associated with one of the workloads 112 for the last hour, the last day, the last week, the last month, etc. Each time a particular flow event is repeated within the particular time interval, Flow log Agent 114 may aggregate the flow events instead of keeping each instance of the flow event in the flow log.

Flow Log Agent 114 is configured to forward the flow log to Flow Log Receiver 141 via Network 131. Network 131 may be one or more of the following: a local area network, a wide area network, a wired network, a wireless network, the Internet, an intranet, or any other appropriate communication network.

Workload Host 121 may be configured in a similar manner as Workload Host 111. Workload Host 121 includes a set of workloads 122, a Host Kernel 123, a Flow Log Agent 124, and a Flow Log Data Plane 125.

Workload Host 121 is configured to receive a set of one or more workloads 122 received from Scheduler 102. Each workload of the set of one or more workloads 122 has an associated IP address. A workload of the set of one or more workloads 122 may be configured to communicate with another workload of the set of one or more workloads 122. A workload of the set of one or more workloads 122 may be configured to communicate with another workload located in the system 100, for example, one of workloads included in the set of one or more workloads 112. A workload of the set of one or more workloads 122 may be configured to communicate with an endpoint external to system 100.

Workload Host 121 includes a Host Kernel 123. Host Kernel 123 is configured to control access to the CPU associated with Workload Host 121, memory associated with Workload Host 121, input/output requests associated with Workload Host 121, and networking associated with Workload Host 121.

Flow Log Agent 124 may be configured to monitor API Server 103 to determine metadata associated with one or more workloads. Flow Log Agent 124 may be configured to extract and correlate metadata and network policy for the one or more workloads of Workload Host 121 and the one or more workloads of the one or more other workload hosts of the cluster. For example, Flow Log Agent 124 may have access to a data store that stores a data structure identifying the permissions associated with a workload. Flow Log Agent 124 may use such information to determine which workloads of the cluster to which a workload is permitted to communicate and which workloads of the cluster to which the workload is not permitted to communicate.

Flow Log Agent 124 may be configured to program Kernel 123 to include Flow Log Data Plane 125. Flow Log Data Plane 125 is configured to cause Kernel 123 to generate flow events associated with each of the workloads on the host. A flow event may include an IP address associated with a source workload and a destination workload, source and destination ports, a protocol used, as well as the network metrics associated with the flow. Flow Log Data Plane 125 may cause Host Kernel 123 to record the standard network 5-tuple as a flow event and to provide the flow event to Flow Log Agent 124. In some embodiments, the Flow Log Data Plane 125 is configured to cause Kernel 123 to include workload metadata and/or network policy metadata in the generated flow events.

In response to receiving the flow event from Host Kernel 123, Flow Log Agent 124 is configured to process with the flow event by adding the metadata of the workload for which the flow event is associated. For example, Host Kernel 123 may provide a flow event that includes the source IP address, the source port, the destination IP address, a destination port, and the protocol. The flow event may also include network metrics associated with the flow, such as the number of bytes and packets. Flow Log Agent 124 is configured to determine the workload to which the flow event pertains. Flow Log Agent 124 may determine this information based on the IP address associated with a workload or based on network interface associated with a workload. Flow Log Agent 124 is configured to combine the flow event information with metadata associated with the workload, such as the cluster identity associated with the workload, a namespace identity associated with the workload, the workload identity, and/or one or more labels associated with the workload. Flow Log Agent 124 is configured to combine the flow event information with metadata associated with the network policy related to the flow event, such as the list of network policy clauses that resulted in the communication being permitted or not permitted. Flow Log Agent 124 is configured to store the combined flow event as a scalable network flow event. Each event included in the flow log includes the pertinent information associated with a workload when the flow log entry is generated. Thus, when the flow log is reviewed at a later time, the flow log may be easily understood as to which workload communicated with which other workload in the cluster, and which network policy clauses were involved in determining whether the communication was permitted or not permitted.

Flow Log Agent 124 is configured to aggregate flow log events for the set of one or more workloads 122 in a manner that Flow Log Agent 122 is configured to aggregate flow log events for the set of one or more workloads 112. Flow Log Agent 124 is configured to provide one or more flow logs to Flow Log Receiver 141. Flow Log Agent 124 may periodically (e.g., every second, every hour, every day, every week, etc.) send one or more flow logs to Flow Log Receiver 141. In other embodiments, Flow Log Agent 124 is configured to send one or more flow logs to the Flow Log Receiver 141 in response to receiving a command. In other embodiments, Flow Log Agent 124 is configured to send one or more flow logs to the Flow Log Receiver 141 after a threshold number of flow events have accumulated.

Flow Log Receiver 141 is configured to receive a plurality of flow logs comprising a plurality of flow events (aggregated and/or non-aggregated) from Flow Log Agents 114, 124, to collate the flow events, and to store the flow events in Flow Log Store 151. Flow Log Receiver 141 may be implemented on a computing device (e.g., computer, server, cloud computing device, mobile device, smart devices, etc.). Flow Log Store 151 may be implemented on a computing device (e.g., computer, server, cloud computing device, mobile device, smart devices, etc.). Flow Log Receiver 141 may be configured to manage Flow Log Store 151, and optimize the manner in which the flow events are stored. The scalable network flow event provides Flow Log Receiver 141 with the ability to perform an additional level of aggregation on the flow events received from Flow Log Agents 114, 124.

Flow Log Receiver 141 may use the scalable network flow event to perform a second level of aggregation based on one or more of a hierarchy inferred from metadata associated with a workload, an entropy analysis of metadata associated with a workload, replication identity, ephemeral elements of the network 5-tuple, and/or a time interval. For example, Flow Log Receiver 141 may determine that a plurality of workloads hosted on a plurality of workload hosts and having the same workload label are communicating with a particular workload. Flow Log Receiver 141 may combine the flow events received from a plurality of workload hosts for the workloads having the same workload label into a single flow event indicating the number of times the workloads having the same workload label communicated with the particular workload.

Since Flow Log Receiver 141 has a complete picture of the network flows for the cluster, Flow Log Receiver 141 may combine flow events (aggregated and non-aggregated) from Workload Hosts 111, 121. For example, a workload may be hosted on Workload Host 111 and have a first IP address. The workload may be migrated to Workload Host 121 and have a second IP address. The flow events of the workload that occurred while on Workload Host 111 and Workload Host 121 may be aggregated because Flow Log Receiver 141 has the metadata associated with the workload. The workload while hosted on the Workload Host 111 may communicate a plurality of times with a second workload. The workload while hosted on Workload Host 121 may also communicate a plurality of times with the second workload. Each respective Flow Log Agent 114, 124 may aggregate the flow events into a single flow event. Flow Log Receiver 141 may receive the aggregated flow events from Flow Log Agent 114 and Flow Log Agent 124. Instead of storing two separate flow events, Flow Log Receiver 141 may perform a second level of aggregation and combine the flow event from Flow Log Agent 114 with the flow event from Flow Log Agent 124 because Flow Log Receiver 141 knows that the flow events are associated with the same workload.

After Flow Log Receiver 141 has stored a plurality of flow events to Flow Log Store 151, Flow Log Receiver 141 may be configured to perform an additional level of aggregation on the stored flow events. Flow Log Receiver is configured to monitor the amount of storage used by Flow Log Store 151 to store the flow events. In some embodiments, Flow Log Receiver 141 performs an additional level of aggregation on the stored flow events based on one or more of a hierarchy inferred from metadata associated with a workload, an entropy analysis of metadata associated with a workload, replication identity, ephemeral elements of the network 5-tuple, and/or a time interval. For example, Flow Log Store 151 may receive and store sets of flow events. A first set may be associated with a first time period and a second set may be associated with a second time period. A flow event associated with the first time period may indicate that a first workload has communicated a plurality of times with a second workload. A flow event associated with the second time period may indicate that the first workload has communicated a plurality of times with the second workload. Instead of storing two separate flow events for the two time periods, Flow Log Receiver 141 may be configured to optimize the stored flow events and combine the flow events into a single flow event indicating the number of times that the first workload communicated with the second workload. This helps to reduce the amount of memory used by Flow Log Store 151 to store the flow logs and allows the Flow Log Store 151 to store additional flow logs.

In some embodiments, Flow Log Receiver 141 is configured to remove one or more flow events from the flow log store based on one or more retention policies. For example, a policy may indicate that flow events for workloads having a particular label are to be removed from Flow Log Store 151 after a particular period of time (e.g., 1 year). In the event the flow event is a non-aggregated flow event, Flow Log Receiver 141 may be configured to remove the flow event from Flow Log Store 151. In the event the flow event is an aggregated flow event and one or more flow events of the aggregated flow event occurred after the particular period of time, Flow Log Receiver 141 is configured to keep the flow event, but decrease the indicator associated with the flow event by the number corresponding to the one or more events that occurred after the particular period of time. For example, suppose an aggregated flow event indicates that a particular flow occurred ten times. Three of those flow events may have occurred after the particular period of time. Flow Log Receiver 141 is configured to keep the flow event, but decrease the indicator such that it indicates that the particular flow occurred seven times. In the event the flow event is an aggregated flow event and all of the flow events of the aggregated flow event occurred after the particular period of time, Flow Log Receiver 141 is configured to remove the flow event form the Flow Log Store 151. This also helps to reduce the amount of storage used by the Flow Log Store 151 to store the flow logs and allows the Flow Log Store 151 to store additional flow logs.

The level of aggregation performed by one of the Flow Low Agents 114, 124 and/or Flow Log Receiver 141 is dynamically automated based on an assessment of the significance of an individual flow event and a load on the overall processing and storage system. For example, if a flow is unexpected, then the full details of the flow may be recorded without any aggregation, but if a flow is business as usual, i.e., expected, and there is pressure on the storage, then the flow may be aggregated with other flows of the same type. For example, heuristics may be used to determine whether a flow is expected. Heuristics may also be used to consider the network policy associated with the workloads, dynamically learn traffic patterns for the workloads, and pattern match thresholds or other operator defined criteria. Similarly, under a distributed denial of service (DDOS) attack, the level and mix of aggregation decisions will dynamically adjust in such a way to ensure there is a mix of detailed logs for forensics and aggregated logs to determine the overall volume and shape of the attack.

Flow log aggregation may also be automatically adjusted based on incident detection machine learning pipelines. For example, if a particular flow metric is determined to be abnormal (based on machine learning of patterns across multiple metrics over time), more aggressive flow logging corresponding to the particular flow metric will be automatically enabled. The more aggressive flow logs are fed into a compromise analysis pipeline. If a compromise is confirmed, then automate corrective actions may be triggered, for example, isolating a compromised workload. This helps to ensure that the workloads and workload hosts of the cluster are working properly and are not compromised.

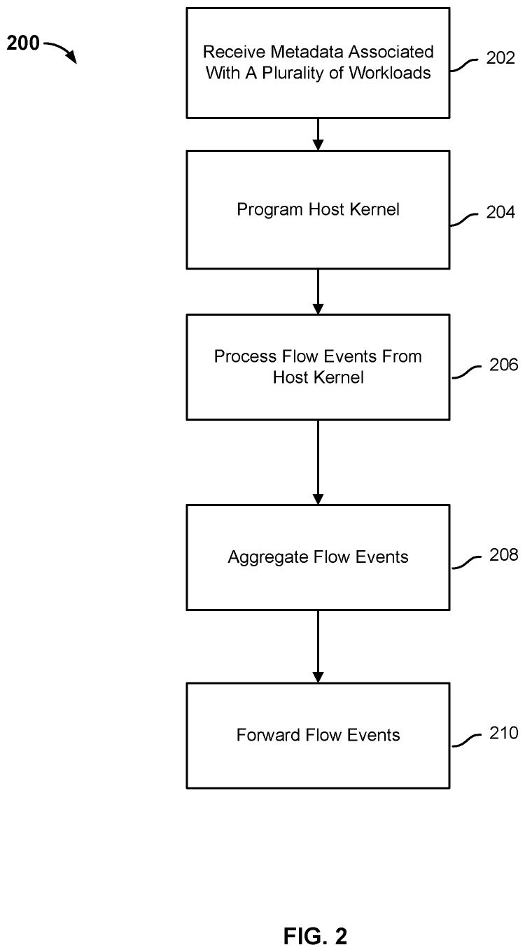

FIG. 2 is a flow chart illustrating an embodiment of a process for implementing scalable network flow events. In the example shown, process 200 may be implemented by a flow log agent, such as flow log agent 114 or flow log agent 124.

At 202, metadata associated with a plurality of workloads is received. A workload may be a container, a pod, a virtual machine, or a host. A flow log agent may be configured to monitor the API server of an orchestration system (e.g., a container-orchestration system) to determine the workload identity and metadata associated with each workload in the cluster. Such workload identity and metadata may include a cluster identity associated with a workload, a namespace identity associated with the workload, the workload identity, and/or one or more labels associated with the workload. The flow log agent may be configured to extract and correlate metadata and network policy for the one or more workloads of the workload host on which the flow log agent is deployed and the one or more workloads of the one or more other workload hosts of the cluster.

At 204, a host kernel is programmed. The flow log agent may be configured to program the kernel of the workload host to which the flow log agent is deployed to generate flow events associated with each of the workloads on the workload host. The flow event may include the standard 5-tuple (source IP address, source port, destination IP address, destination port, protocol) flow as well as the network metrics associated with the flow (e.g., number of bytes and packets). In some embodiments, the flow event may include workload metadata and/or network policy metadata in the generated flow events.

At 206, flow events are processed from the host kernel. The flow log agent may be configured to combine the generated flow event with the workload identity and metadata associated with the workload and/or network policy metadata associated with the flow event. Thus, each flow event is a scalable network flow event. The scalable network flow event includes the pertinent information associated with a workload and network policy when the flow event is generated. Thus, when the flow log comprising a plurality of flow events is reviewed at a later time, the flow log may be easily understood as to which workload communicated with which other workload in the cluster and which network policy clauses were involved in determining whether the communication was permitted or not permitted. A flow event may include information on whether a particular flow/communication was permitted or denied. The flow event may also indicate whether the flow/communication was permitted or denied based on a network policy. The flow event may indicate the particular network policy.

At 208, a plurality of flow events are aggregated. The amount of storage of a workload host to store the one or more flow logs is finite. However, the size of the flow log continues to expand as the plurality of workloads continue to generate flow events. Additional storage may be added or provisioned to a workload host, but the costs associated with the additional storage may be prohibitive for an entity associated with the workload host or adding storage may be unfeasible. The flow log agent may be configured to aggregate, based on the scalable network flow event, the flow events associated with each workload of the host on which the flow log agent is deployed.

The flow log agent associated with a workload host may use the information associated with the scalable network flow event to aggregate a plurality of flow events into a single flow event. For example, the flow log agent may use the scalable network flow event to aggregate based on one or more of a hierarchy inferred from metadata associated with a workload, an entropy analysis of metadata associated with a workload, replication identity, ephemeral elements of the network 5-tuple, and/or a time interval. The aggregated flow events may include aggregated metrics across all of the flow logs that were aggregated (e.g., number of flows, sum of packets, sum of bytes, etc.).

A hierarchy may be inferred from the metadata associated with a workload. The workload may have associated metadata such as an associated cluster identity, an associated namespace identity, an associated workload identity, one or more associated workload labels, an associated region, an associated network, an associated security group, etc. A flow log agent may be configured to aggregate flow events for one or more workloads having particular metadata (and in some embodiments, not aggregate flow events for one or more workloads not having the particular metadata). For example, a flow log agent associated with a workload host may aggregate flow events for workloads having a particular cluster identity, a particular namespace identity, a particular workload identity, and/or a particular set of workload labels. A plurality of flow events having the same metadata associated with a workload may be aggregated into a single flow event. The single flow event may include an indicator that indicates the number of times that the flow occurred. For example, a workload host may include a plurality of workloads having a first workload label. Each of the workloads having the first workload label may communicate a plurality of times with a second workload. Instead of storing a flow event for each communication, the flow events for the workloads having the first workload label may be aggregated into a single flow event and the single flow event may include an indicator that indicates the number of times the workloads having the first workload label communicated with the second workload.

An entropy analysis of the metadata associated with a workload may be performed. The flow log may include a plurality of scalable network flow events associated with a workload. In some embodiments, one or more fields of the scalable network flow event may be determined to be completely random and/or not correlated with other fields or properties of a plurality of scalable network flow events. For example, a source port used by a workload for each flow event may be different. In some embodiments, the one or more fields of the scalable network flow event that are random may be discarded from the flow log. In some embodiments, the one or more fields of the scalable network flow event that are not correlated with other fields or properties of a plurality of scalable network flow events may be discarded from the flow log. This reduces the amount of storage needed to store the flow log and also enables the workload host to store more flow logs.

A replication identity associated with a workload may be determined. A workload may be associated with an instance of a micro service. There may be a plurality of micro service instances running at the same time on the same workload host, e.g., a plurality of workloads of a workload host running the same micro service. Instead of storing a flow event for each communication of micro service instances, the flow events of the micro services may be combined into a single flow log.

Elements of the standard network 5-tuple (source IP address, source port, destination IP address, protocol) may be ephemeral (e.g., lasting for a short period of time). For example, an IP address associated with a source workload of the workload host (e.g., a communication is sent from a workload of the workload host) or destination workload of the workload host (e.g., a communication is received from a workload of the workload host) may exist for a short period of time (e.g., one hour, one day, one week, etc.). A source port associated with a source workload may exist for a short period of time. A protocol associated with a communication may exist for a short period of time.

The flow events associated with the ephemeral element of the standard network 5-tuple may be aggregated. For example, the flow events associated with a duration in which a source workload has an associated IP address may be aggregated. A workload may be migrated between workload hosts and have different IP addresses on each workload host. For example, the workload may have a first IP address on a workload host and a second IP address on a different workload host. The flow events for the duration when the workload has the first IP address may be aggregated by the flow log agent associated with the workload host. The flow events for the duration when the workload has the second IP address may also be separately aggregated by the flow log agent associated with the different workload host.

The flow events associated with a duration when a workload uses a particular source port may be aggregated. For example, a workload may use a first source port for a first period of time and may use a second source port for a second period of time. The flow events for the first period of time may be aggregated by the flow log agent associated with the workload host. The flow events for the second period of time may also be separately aggregated.

The flow events associated with a duration in which a destination workload has an associated IP address may be aggregated. A workload may be migrated between workload hosts and have different IP addresses on each host. For example, the workload may have a first IP address on a first workload host and a second IP address on a second workload hosts. The flow events for the duration when a source workload is communicating with a destination workload having the first IP address may be aggregated. The flow events for the duration when a source workload is communicating with the destination workload having the second IP address may be separately aggregated.

The flow events associated with a duration in which a protocol is used may be aggregated. For example, a workload may use a first protocol during a first period of time and a second protocol during a second period of time. The flow events for the duration when the first protocol is used may be aggregated. The flow events for the duration when the second protocol is used may be separately aggregated.

The flow log receiver may aggregate flow events associated with a workload for a particular time interval. For example, the flow log receiver may aggregate flow events associated with a workload for the last hour, the last day, the last week, the last month, etc. Each time a particular flow event is repeated within the particular time interval, the flow log receiver may aggregate the flow events instead of keeping each instance of the flow event.

The flow log agent associated with a workload host may store one or more flow logs associated with the workload host. A flow log may be comprised of one or more flow events. In some embodiments, the flow log is comprised of one or more non-aggregated flow events. In other embodiments, the flow log is comprised of one or more aggregated flow events. In other embodiments, the flow log is comprised of one or more non-aggregated flow events and one or more aggregated flow events.

At 210, the flow log (including aggregated and/or non-aggregated flows) is provided to a flow log receiver. A flow log agent may be configured to periodically send (e.g., every hour, every day, every week, etc.) the flow log to a flow log receiver. In other embodiments, the flow log agent is configured to send the flow log to the flow log receiver in response to receiving a command. In other embodiments, the flow log agent is configured to send the flow log to the flow log receiver after a threshold number of flow events have accumulated. After the flow log is provided to a flow log receiver, the flow log agent may delete the flow events associated with the flow log. This frees up storage for one or more subsequent flow events.

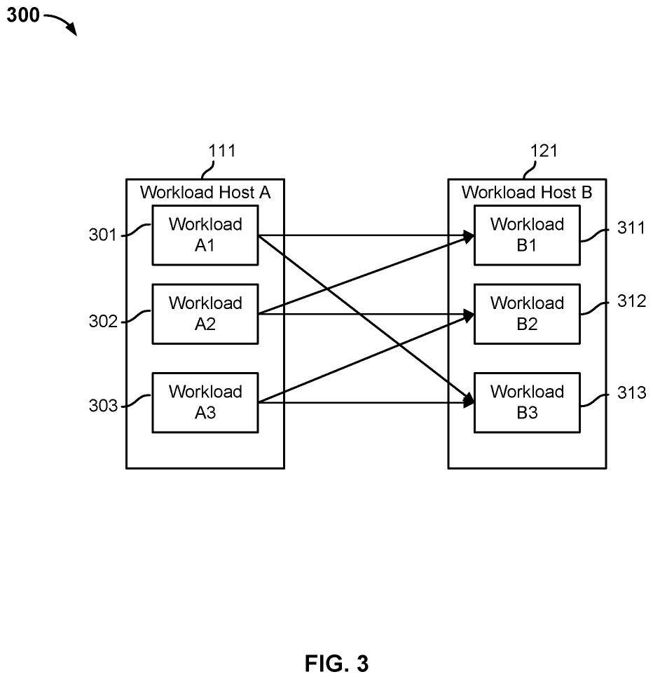

FIG. 3 is a diagram illustrating workload hosts in accordance with some embodiments. In the example shown, Workload Host 111 includes three workloads that are pods (e.g., containers that may themselves contain nested groups of containers) running three corresponding instances of a first micro service. The first instance of the first micro service is running on Workload 301, the second instance of the first micro service is running on Workload 302, and the third instance of the first micro service is running on Workload 303.

Workload Host 121 includes three workloads running three corresponding instances of a second micro service. The first instance of the second micro service is running on Workload 311, the second instance of the second micro service is running on Workload 312, and the third instance of the second micro service is running on Workload 313.

In the example shown, Workload 301 has communicated with Workloads 311, 313. Workload 302 has communicated with Workloads 311, 312. Workload 303 has communicated with Workloads 312, 313. A total of six communications have occurred between the first micro service and the second micro service. Instead of logging each communication for each instance of the micro service (e.g., six flow events), the communications may be aggregated into a single flow event because the first micro service as a whole has communicated with the second micro service as a whole. The single flow event may include an indication of the number of times that the first micro service communicated with the second micro service. In the example shown, the single flow event would include an indication of six. In some embodiments, the flow event may include a timestamp associated with each aggregated communication.

In some embodiments, instances of a micro service are deployed to a plurality of workload hosts. For example, Workloads 301, 302 may be deployed to Workload Host 111 and Workload 303 may be deployed to Workload Host 121 while Workloads 311, 313 may be deployed to Workload Host 121 and Workload 312 may be deployed to Workload Host 111.

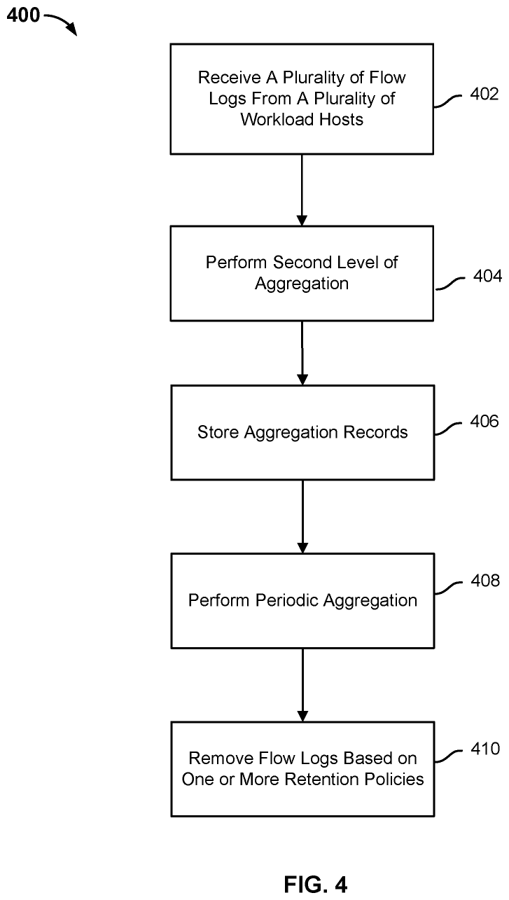

FIG. 4 is a flow chart illustrating an embodiment of a process for aggregating flow events. In the example shown, process 400 may be implemented by a flow log receiver, such as flow log receiver 141.

At 402, a plurality of flow logs comprising a plurality of flow events are received from a plurality of workload hosts. Each flow log agent associated with a workload host is configured to provide a flow log comprising a plurality of flow events (aggregated and/or non-aggregated) to a flow log receiver. The flow log receiver may receive a plurality of flow logs from a plurality of workload hosts of the cluster and collate the flow logs.

At 404, the flow logs from the plurality of workload hosts are aggregated. A flow log receiver may be configured to manage the flow log store and optimize the manner in which the flow logs are stored. Instead of storing each instance of a received flow event (whether aggregated or non-aggregated), the scalable network flow event enables the flow log receiver to perform a second level of aggregation on the flow logs. The flow log receiver may perform a second level of aggregation use the scalable network flow event to perform a second level of aggregation based on one or more of a hierarchy inferred from metadata associated with a workload, an entropy analysis of metadata associated with a workload, replication identity, ephemeral elements of the network 5-tuple, and/or a time interval. For example, the flow log receiver may determine that a plurality of workloads hosted on a plurality of workload hosts and having the same workload label are communicating with a particular workload. The flow log receiver may combine the flow events received from a plurality of workload hosts for the workloads having the same workload label into a single flow event indicating the number of times the workloads having the same workload label communicated with the particular workload.

Since the flow log receiver has a complete picture of the network flows for the cluster, the flow log receiver may combine flow events (aggregated and non-aggregated) from a plurality of workload hosts. For example, a workload may be hosted on a first workload host and have a first IP address. The workload may be migrated to a second workload host and have a second IP address. The flow events of the workload that occurred while on the first workload host and the second workload host may be aggregated because the flow log receiver has the metadata associated with the workload. The workload while hosted on the first workload host may communicate a plurality of times with a second workload. The workload while hosted on the second workload host may also communicate a plurality of times with the second workload. Each respective flow log agent may aggregate the flow events into a single flow event. The flow log receiver may receive the aggregated flow events from the flow log agent of the first workload host and the flow log agent of the second workload host. Instead of storing two separate flow events, the flow log receiver may perform a second level of aggregation and combine the flow event from the flow log agent of the first workload host with the flow event from the flow log agent of the second workload host because the flow log receiver knows that the flow events are associated with the same workload.

The level of aggregation is dynamically automated based on an assessment of the significant of individual flow events and a load on the overall processing and storage system. For example, if a flow is unexpected, then the full details of the flow may be recorded without any aggregation, but if a flow is business as usual, i.e., expected, and there is pressure on the storage, then the flow may be aggregated with other flows of the same type. For example, heuristics may be used to determine whether a flow is expected. Heuristics may also be used to consider the network policy associated with the workloads, dynamically learn traffic patterns for the workloads, and pattern match thresholds or other operator defined criteria. Similarly, under a DDOS attack, the level and mix of aggregation decisions will dynamically adjust in such a way to ensure there is a mix of detailed logs for forensics and aggregated logs to determine the overall volume and shape of the attack.

Flow log aggregation may also be automatically adjusted based on incident detection machine learning pipelines. For example, if a particular flow metric is determined to be abnormal (based on machine learning of patterns across multiple metrics over time), more aggressive flow logging corresponding to the particular flow metric will be automatically enabled. The more aggressive flow logs are fed into a compromise analysis pipeline. If a compromise is confirmed, then automate corrective actions may be triggered, for example, isolating a compromised workload.

At 406, the flow events (aggregated and non-aggregated) are stored to a flow log store. At 408, periodic aggregation is performed. After the flow log receiver has stored a plurality of flow events to a flow log store, the flow log receiver may be configured to perform an additional level of aggregation on the stored flow events. The flow log receiver is configured to monitor the amount of storage used by the flow log store to store the flow events. In some embodiments, the flow log receiver performs an additional level of aggregation on the stored flow events based on one or more of a hierarchy inferred from metadata associated with a workload, an entropy analysis of metadata associated with a workload, replication identity, ephemeral elements of the network 5-tuple, and/or a time interval. For example, the flow log store may receive and store sets of flow events. A first set may be associated with a first time period and a second set may be associated with a second time period. A flow event associated with the first time period may indicate that a first workload has communicated a plurality of times with a second workload. A flow event associated with the second time period may indicate that the first workload has communicated a plurality of times with the second workload. Instead of storing two separate flow events for the two time periods, the flow log receiver may be configured to optimize the stored flow events and combine the flow events into a single flow event indicating the number of times that the first workload communicated with the second workload. This helps to reduce the amount of memory used by the flow log store to store the flow logs and allows the flow log store to store additional flow logs.

At 410, flow logs are removed from the flow log store based on one or more retention policies. For example, a policy may indicate that flow events for workloads having a particular label are to be removed from the flow log store after a particular period of time (e.g., 1 year). In the event the flow event is a non-aggregated flow event, the flow log receiver may be configured to remove the flow event from the flow log store. In the event the flow event is an aggregated flow event and one or more flow events of the aggregated flow event occurred after the particular period of time, the flow log receiver is configured to keep the flow event, but decrease the indicator associated with the flow event by the number corresponding to the one or more events that occurred after the particular period of time. For example, suppose an aggregated flow event indicates that a particular flow occurred ten times. Three of those flow events may have occurred after the particular period of time. The flow log receiver is configured to keep the flow event, but decrease the indicator such that it indicates that the particular flow occurred seven times. In the event the flow event is an aggregated flow event and all of the flow events of the aggregated flow event occurred after the particular period of time, the flow log receiver is configured to remove the flow event form the flow log store. This also helps to reduce the amount of memory used by the flow log store to store the flow logs and allows the flow log store to store additional flow logs.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
cause a host to generate one or more flow events associated with a workload based on metadata associated with the workload; and
process the one or more flow events generated by the host to generate one or more corresponding scalable network flow events, wherein the one or more corresponding scalable network flow events are based in part on the metadata associated with the workload; and
a communication interface coupled to the processor and configured to forward a flow log comprising the one or more corresponding scalable network flow events to a flow log receiver.

2. The system of claim 1, wherein the processor is configured to receive the metadata associated with the workload, wherein the workload is one of a plurality of workloads hosted on the host.

3. The system of claim 1, wherein the flow log receiver is configured to store the one or more corresponding scalable network flow events in a flow log store.

4. The system of claim 1, wherein the metadata associated with the workload includes at least one of a cluster identity associated with the workload, a namespace associated with the workload, a workload identity, one or more labels associated with the workload, or a network policy associated with the workload.

5. The system of claim 1, wherein the one or more flow events generated by the host include at least one of an internet protocol address associated with a source workload, a source port associated with the source workload, an internet protocol address associated with a destination workload, a destination port associated with the destination workload, a protocol, information indicating whether the communication was permitted or denied, or information detailing which policies resulted in the communication being permitted or denied.

6. The system of claim 1, wherein to generate one or more corresponding scalable network flow events, the processor is configured to combine the metadata associated with the workload with information included in the one or more flow events.

7. The system of claim 1, wherein the processor is further configured to aggregate the one or more corresponding scalable network flow events based on a hierarchy inferred from the metadata associated with the workload.

8. The system of claim 1, wherein the processor is further configured to aggregate the one or more corresponding scalable network flow events based on an entropy analysis of the metadata associated with the workloads.

9. The system of claim 1, wherein the processor is further configured to aggregate the one or more corresponding scalable network flow events based on a replication identity.

10. The system of claim 1, wherein the processor is further configured to aggregate the one or more corresponding scalable network flow events based on ephemeral elements of the one or more flow events.

11. The system of claim 1, wherein the processor is further configured to aggregate the one or more corresponding scalable network flow events based on a time interval.

12. The system of claim 1, wherein the processor is further configured to prevent the workload from communicating with one or more other workloads until the metadata associated with the workload is received.

13. The system of claim 1, wherein the processor is further configured to permit the one or more flow events based on a network policy.

14. The system of claim 13, wherein the network policy indicates one or more other workloads with which the workload is permitted to communicate.

15. The system of claim 1, wherein the flow log receiver is configured to receive a plurality of flow logs from a plurality of hosts, wherein the plurality of flow logs includes the flow log and the plurality of hosts includes the host.

16. The system of claim 15, wherein the flow log receiver is configured to aggregate the plurality of flow logs based on at least one of a hierarchy inferred from the metadata associated with the workload, an entropy analysis of the metadata associated with the workload, a replication identity, ephemeral elements of the one or more flow events, or a time interval.

17. The system of claim 1, wherein the flow log receiver is configured to perform periodic aggregation on flow events stored in a flow log store.

18. The system of claim 1, wherein the flow log receiver is configured to remove one or more flow events from a flow log store based on one or more retention policies.

19. A method, comprising:
causing a host to generate one or more flow events associated with the workload based on metadata associated with the workload;
processing the one or more flow events generated by the host to generate one or more corresponding scalable network flow events, wherein the one or more corresponding scalable network flow events are based in part on the metadata associated with the workload; and
forwarding a flow log comprising the one or more corresponding scalable network flow events to a flow log receiver.

20. A computer program product, the computer program product being embodied in a non-transitory computer readable storage medium and comprising computer instructions for:
causing a host to generate one or more flow events associated with the workload based on metadata associated with the workload;
processing the one or more flow events generated by the host to generate one or more corresponding scalable network flow events, wherein the one or more corresponding scalable network flow events are based in part on the metadata associated with the workload; and
forwarding a flow log comprising the one or more corresponding scalable network flow events to a flow log receiver.
